(19) United States
(12) Patent Application Publication
(10) Pub. No.: US 2019/0161958 A1
(43) Pub. Date: May 30, 2019

(54) Inflatable Greenhouse Panel Joiner

(71) Applicant: Zeev Barsheshet, San Diego, CA (US)

(72) Inventor: Zeev Barsheshet, San Diego, CA (US)

(21) Appl. No.: 16/205,519

(22) Filed: Nov. 30, 2018

Related U.S. Application Data
(60) Provisional application No. 62/592,610, filed on Nov. 30, 2017.

(51) Int. Cl. E04B 1/41; A01G 9/16; E04H 15/00

(52) U.S. Cl. CPC E04B 1/40; E04H 15/008; A01G 9/16

(57) ABSTRACT

An inflatable greenhouse panel joiner includes a middle circular tube, a first circular tube, and a second circular tube. Each tube includes an input base and an output base for the user to introduce supporting materials. The first circular tube and the second circular tube both include a pair of filleted edges for the user to slide the panel into the first or second circular tube, respectively. The panel joiner allows the user to join multiple plastic panels with support material to build or modify a greenhouse with minimum effort.

The current application claims a priority to the U.S. Provisional Patent application Ser. No. 62/592,610 filed on Nov. 30, 2017.

### FIELD OF THE INVENTION

The present invention relates generally to a device to join plastic panels. More specifically, the present invention is a flexible connector in one continuous unit configured to allow the user to join multiple plastic panels with supporting material to build an inflatable greenhouse or tent without limitation of length or width.

### BACKGROUND OF THE INVENTION

As agricultural technology improves on a daily basis, many methods or equipment are invented to improve both the quality and quantity of agricultural products. With the assistance of greenhouse, many crops can now be grown in many different locations or weather. However, many issues arise relating to greenhouse building. First, building a greenhouse can be both expensive and time-consuming, which may not be the most efficient method to facilitate the growth of plants. Second, once a greenhouse is built, it hard to expand or reduce the area covered by the greenhouse. The user may need to build another greenhouse to cover more area or need to significantly modify the existing greenhouse to reduce the covered area. Both expansion or reduction takes significant amount of time and effort, which can cause significant delay in agriculture.

The present invention provides solutions to all the issues mentioned above by providing a device to join two or more plastic panels or plastic sheets with multiple supporting structures to build an inflatable greenhouse. The present invention comprises three jointed hollow tubes that allow the user to introduce a support material into the middle tube and introduce plastic panels to the two side tubes. The present invention is made from flexible material and allows the user to bend the present invention and the joined plastic panels into different shape or curvature. With the present invention, the user can quickly build and disassemble a greenhouse by joining multiple plastic panels with several supporting material. Moreover, if the user wishes to expand or reduce the greenhouse, the user only needs to join more plastic panels with the present invention to expand the greenhouse or take out plastic panels by removing the present invention to reduce the greenhouse. In other words, the present invention provides more flexibility for the user to customize the shape and size of the existing greenhouse with minimum effort.

### BRIEF DESCRIPTION OF THE DRAWINGS

FIG. 1 is a front perspective view of the present invention.

FIG. 2 is a rear perspective view of the present invention.

FIG. 3 is a front view of the present invention.

FIG. 4 is a side view of the present invention, showing the second circular tube.

FIG. 5 is a side view of the present invention, showing the first circular tube.

### DETAIL DESCRIPTIONS OF THE INVENTION

All illustrations of the drawings are for the purpose of describing selected versions of the present invention and are not intended to limit the scope of the present invention.

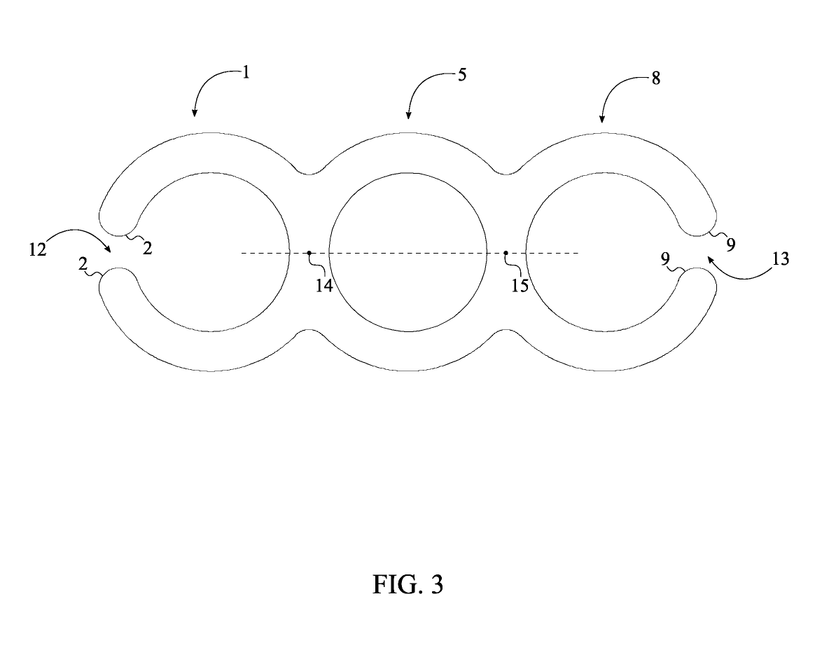

In reference to FIG. 3, the present invention is an inflatable greenhouse panel joiner to join two or more plastic panels together to create a tent or a greenhouse structure. The present invention comprises a first circular tube 1, a middle circular tube 5, a second circular tube 8, a first panel receiving opening 12, and a second panel receiving opening 13. The middle circular tube 5 comprises a first tangent intersection point 14 and a second tangent intersection point 15. The first tangent intersection point 14 is positioned between the first circular tube 1 and the middle circular tube 5 and is configured to serve as a connection point between the first circular tube 1 and the middle circular tube 5. The second tangent intersection point 15 is positioned between the second circular tube 8 and the middle circular tube 5 and is configured to serve as a connection point between the second circular tube 8 and the middle circular tube 5. The first circular tube 1 is adjacently connected to the middle circular tube 5 by the first tangent intersection point 14 and is configured to hold one piece of plastic panel or plastic sheet. The second circular tube 8 is adjacently connected to the middle circular tube 5 by the second tangent intersection point 15 and is also configured to hold another piece of plastic panel or plastic sheet.

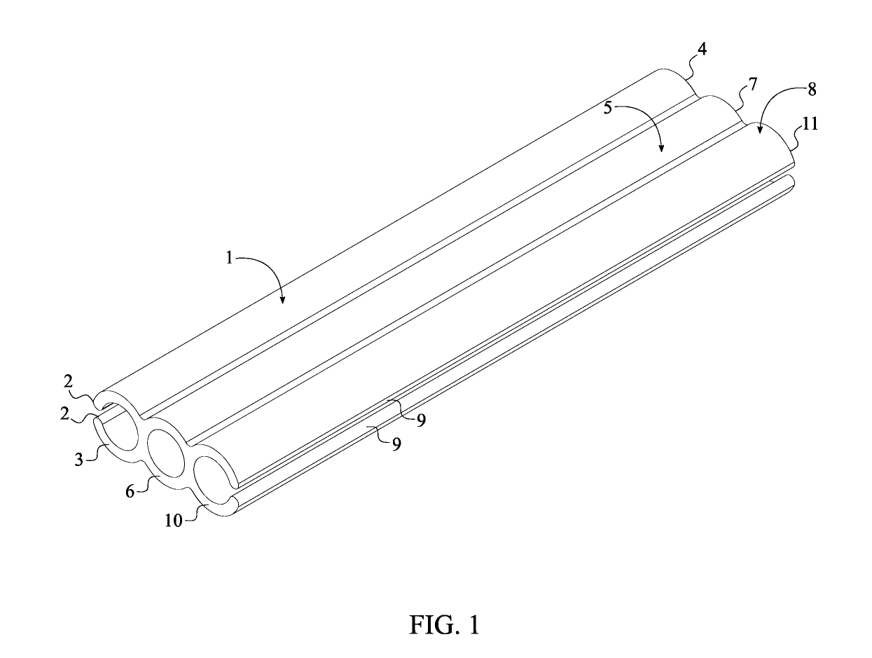

In reference to FIGS. 1 and 3, the first panel receiving opening 12 traverses along the first circular tube 1 and positioned opposite of the second circular tube 8. The first panel receiving opening 12 is configured to allow the plastic panel or plastic sheet held by the first circular tube 1 to be outwardly extend from the inside of the first circular tube 1. The second panel receiving opening 13 traverses along the second circular tube 8 and positioned opposite of the first circular tube 1. The second panel receiving opening 13 is configured to allow the plastic panel or plastic sheet held by the second circular tube 8 to be outwardly extend from the inside of the second circular tube 8.

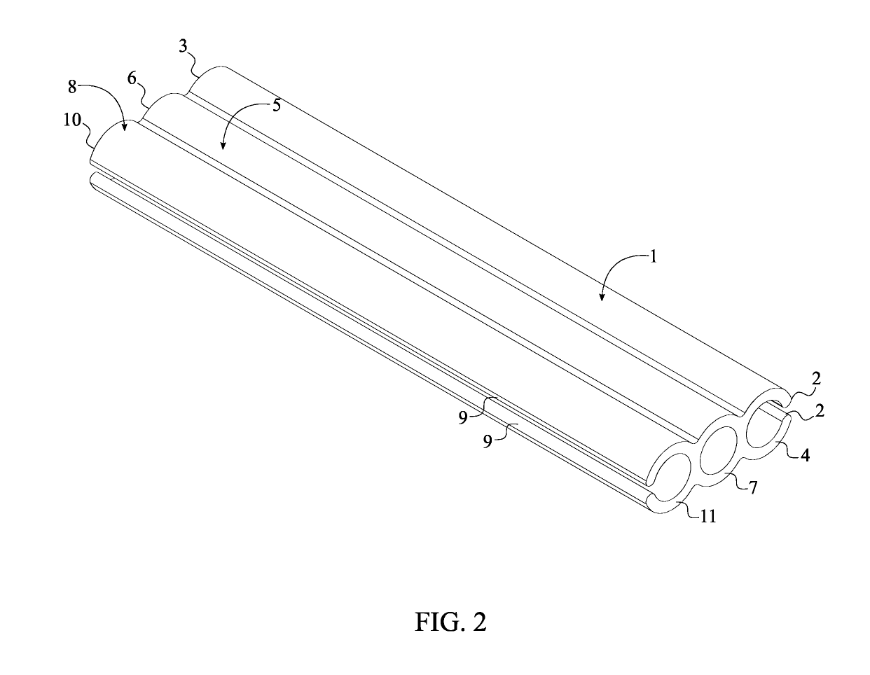

In reference to FIGS. 2 and 3, the first circular tube 1 further comprises a first pair of filleted edges 2. The first pair of filleted edges 2 is oppositely positioned of the second circular tube 8 and is delineated by the first panel receiving opening 12. The first pair of filleted edges 2 is configured to safely hold the plastic panel or plastic sheet in the same position. In other words, filleted edges provide a smooth surface against the plastic so that the plastic will not get damage due slight movement that may happen overtime.

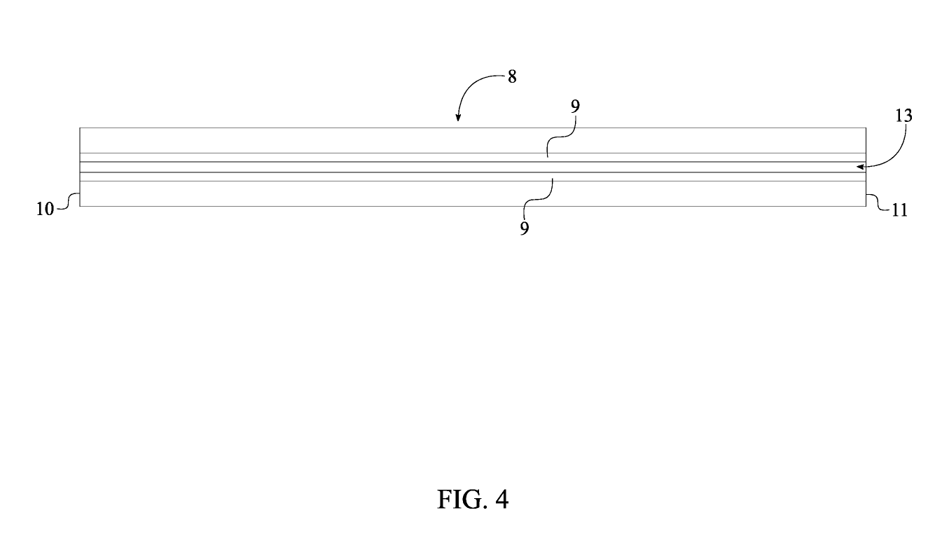

In reference to FIGS. 3 and 4, the second circular tube 8 further comprises a second pair of filleted edge 9. The second pair of filleted edge 9 is oppositely positioned of the first circular tube 1 and is delineated by the second panel receiving opening 13. The second pair of filleted edge 9 is configured to safely hold the plastic panel or plastic sheet in the same position. In other words, filleted edges provides a smooth surface against the plastic so that the plastic will not get damage due slight movement that may happen overtime.

The first tangent intersection point 14 and the second tangent intersection point 15 are diametrically opposed of each other. This configuration is to ensure linear positioning of the first circular tube 1 and the second circular tube 8 with respect to the middle circular tube 5.

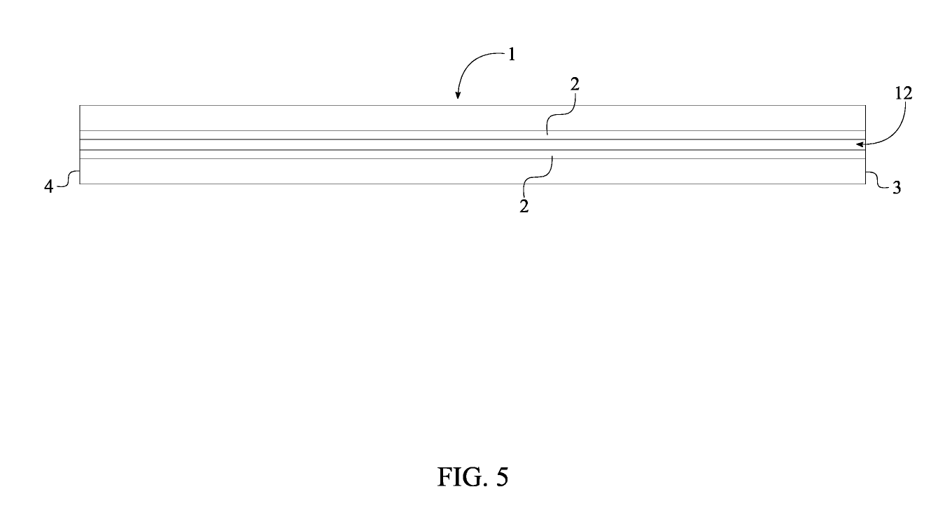

In reference to FIGS. 3 and 5, the first pair of filleted edges 2 is oppositely positioned of the first tangent intersection point 14. The first tangent intersection point 14 being linearly positioned in between the first pair of filleted edges 2 and the second tangent intersection point 15. This configuration between the first pair of filleted edges 2 and the first tangent intersection point 14 allows the user to introduce the plastic panel with a supporting material into the first circular tube 1 to prevent the plastic panel from sliding out of the first circular tube 1 through the first pair of filleted edges 2.

In reference to FIGS. 3 and 4, the second pair of filleted edges 9 is oppositely positioned of the second tangent intersection point 15. The second tangent intersection point 15 being linearly positioned in between the second pair of filleted edges 9 and the first tangent intersection point 15. This configuration between the second pair of filleted edges 9 and the second tangent intersection point 15 allows the user to introduce the plastic panel with a supporting material into the second circular tube 8 to prevent the plastic panel from sliding out of the second circular tube 8 through the second pair of filleted edges 9. In reference to FIGS. 1 and 2, the middle circular tube 5 further comprises an input base 6 and an output base 7. The input base 6 and the output base 7 are parallel to each other and is configured to allow the user to introduce a support via the input base 6, traversing through the middle circular tube 5 and exit from the output base 7. The first circular tube 1 further comprises a first input base 3 and a first output base 4. The first input base 3 is parallelly positioned to the input base 6 of the middle circular tube 5. The first output base 4 is parallelly positioned to the output base 7 of the middle circular tube 5. The first input base 3 is configured to allow the user to introduce a plastic panel or plastic sheet into the first circular tube 1 until the plastic panel is positioned between the first pair of fillet edges 2 via the first input base 3. The first output base 4 is configured to allow the user to remove the plastic panel or plastic sheet from the first circular tube 1. The second circular tube 8 further comprises a second input base 10 and a second output base 11. The second input base 10 is parallelly positioned to the input base 6 of the middle circular tube 5. The second output base 11 is parallelly positioned to the output base 7 of the middle circular tube 5. The second input base 10 is configured to allow the user to introduce a plastic panel or plastic sheet into the second circular tube 8 until the plastic panel is positioned between the second pair of fillet edges 9 via the second input base 10. The second output base 11 is configured to allow the user to remove the plastic panel or plastic sheet from the second circular tube 8.

In reference to FIG. 3, the first circular tube 1 is made of flexible material to allow the user to build the greenhouse in different shapes. The user may bend or modify the present invention to different angles or curvature after introducing the plastic panel into the first circular tube 1. The middle circular tube 5 is made of flexible material to allow the user to build the greenhouse in different shapes. The user may introduce different types of support into the middle circular tube 5 to modify the angle of curvature of the plastic panel. The second circular tube 8 is made of flexible material to allow the user to build the greenhouse in different shapes. The user may bend or modify the present invention to different angles or curvature after introducing the plastic panel into the second circular tube 8.

Although the invention has been explained in relation to its preferred embodiment, it is to be understood that many other possible modifications and variations can be made without departing from the spirit and scope of the invention as hereinafter claimed.

What is claimed is:

1. An inflatable greenhouse panel joiner comprises:
a first circular tube;
a middle circular tube;
a second circular tube;
a first panel receiving opening;
a second panel receiving opening;
the first circular tube further comprises a first pair of filleted edges;
the second circular tube further comprises a second pair of filleted edges;
the middle circular tube further comprises a first tangent intersection point and a second tangent intersection point;
the first circular tube being adjacently connected to the middle circular tube by the first tangent intersection point;
the second circular tube being adjacently connected to the middle circular tube by the second tangent intersection point;
the first panel receiving opening traversing along the first circular tube;
the second panel receiving opening traversing along the second circular tube;
the first pair of filleted edges being delineated by the first panel receiving opening; and
the second pair of filleted edges being delineated by the second panel receiving opening.

2. The inflatable greenhouse panel joiner as claimed in claim 1 comprises:
the first tangent intersection point and the second tangent intersection point being diametrically opposed of each other.

3. The inflatable greenhouse panel joiner as claimed in claim 1 comprises:
the first pair of filleted edges being positioned opposite of the first tangent intersection point; and
the first tangent intersection point being linearly positioned in between the first pair of filleted edges and the second tangent intersection point.

4. The inflatable greenhouse panel joiner as claimed in claim 1 comprises:
the second pair of filleted edges being positioned opposite of the second tangent intersection point; and
the second tangent intersection point being linearly positioned in between the second pair of filleted edges and the first tangent intersection point.

5. The inflatable greenhouse panel joiner as claimed in claim 1 comprises:
the first circular tube comprises a first input base and a first output base;
the middle circular tube comprises an input base and an output base;
the first input base being parallelly positioned to the input base of the middle circular tube; and
the first output base being parallelly positioned to the output base of the middle circular tube.

6. The inflatable greenhouse panel joiner as claimed in claim 1 comprises:
the second circular tube comprises a second input base and a second output base;
the middle circular tube comprises an input base and an output base;
the second input base being parallelly positioned to the input base of the middle circular tube; and
the second output base being parallelly positioned to the output base of the middle circular tube.

7. The inflatable greenhouse panel joiner as claimed in claim 1, wherein the first circular tube being flexible.

8. The inflatable greenhouse panel joiner as claimed in claim 1, wherein the second circular tube being flexible.

9. The inflatable greenhouse panel joiner as claimed in claim 1, wherein the middle circular tube being flexible.

10. An inflatable greenhouse panel joiner comprises:
a first circular tube;
a middle circular tube;
a second circular tube;
a first panel receiving opening;
a second panel receiving opening;
the first circular tube further comprises a first pair of filleted edges;
the second circular tube further comprises a second pair of filleted edges;
the middle circular tube further comprises a first tangent intersection point and a second tangent intersection point;
the first circular tube being adjacently connected to the middle circular tube by the first tangent intersection point;
the second circular tube being adjacently connected to the middle circular tube by the second tangent intersection point;
the first panel receiving opening traversing along the first circular tube;
the second panel receiving opening traversing along the second circular tube;
the first pair of filleted edges being delineated by the first panel receiving opening;
the second pair of filleted edges being delineated by the second panel receiving opening;
the first pair of filleted edges being positioned opposite of the first tangent intersection point;
the first tangent intersection point being linearly positioned in between the first pair of filleted edges and the second tangent intersection point;
the second pair of filleted edges being positioned opposite of the second tangent intersection point; and
the second tangent intersection point being linearly positioned in between the second pair of filleted edges and the first tangent intersection point.

11. The inflatable greenhouse panel joiner as claimed in claim 10 comprises:
the first tangent intersection point and the second tangent intersection point being diametrically opposed of each other.

12. The inflatable greenhouse panel joiner as claimed in claim 10 comprises:
the first circular tube comprises a first input base and a first output base;
the middle circular tube comprises an input base and an output base;
the first input base being parallelly positioned to the input base of the middle circular tube; and
the first output base being parallelly positioned to the output base of the middle circular tube.

13. The inflatable greenhouse panel joiner as claimed in claim 10 comprises:
the second circular tube comprises a second input base and a second output base;
the middle circular tube comprises an input base and an output base;
the second input base being parallelly positioned to the input base of the middle circular tube; and
the second output base being parallelly positioned to the output base of the middle circular tube.

14. The inflatable greenhouse panel joiner as claimed in claim 10, wherein the first circular tube being flexible.

15. The inflatable greenhouse panel joiner as claimed in claim 10, wherein the second circular tube being flexible.

16. The inflatable greenhouse panel joiner as claimed in claim 10, wherein the middle circular tube being flexible.
